(19) United States
(12) Patent Application Publication
(10) Pub. No.: US 2024/0320336 A1
(43) Pub. Date: Sep. 26, 2024

(54) ZOOM-IN SNAPSHOTS FOR WRITING PROCESSES

(71) Applicant: Dell Products L.P., Round Rock, TX (US)

(72) Inventors: Ofir Ezrielev, Be’er Sheba (IL); Yehiel Zohar, Sderot (IL); Yevgeni Gehtman, Modi'in (IL); Tomer Shachar, Beer-Sheva (IL); Maxim Balin, Gan-Yavne (IL)

(21) Appl. No.: 18/189,554

(22) Filed: Mar. 24, 2023

(51) Int. Cl. G06F 21/56; G06F 21/53

(52) U.S. Cl. CPC G06F 21/566; G06F 21/53; G06F 21/564

(57) ABSTRACT

One example method includes identifying a candidate process for monitoring, while the candidate process is running, taking a set of snapshots of the candidate process, and each of the snapshots corresponds to a respective time period during which the candidate process was running, analyzing the snapshots to determine whether the candidate process comprises a ransomware process, and when a counter indicates that the candidate process includes a number of write operations that exceeds a threshold, the candidate process is identified as a ransomware process.

### FIELD OF THE INVENTION

Embodiments of the present invention generally relate to detection and identification of malware, such as ransomware. More particularly, at least some embodiments of the invention relate to systems, hardware, software, computer-readable media, and methods, for using a group of focused snapshots to identify possibly problematic write processes.

### BACKGROUND

Ransomware is malicious software, or ‘malware,’ designed to block user data access until a sum of money is paid to the attacker. Ransomware is prevalent and a major concern for customers, all over the world. Customers are looking for a way to detect ransomware on a storage array in real-time or near real-time.

Ransomware, like any malware, can gain access to the systems of an organization in several different ways. After ransomware has gained access to a system, it can begin encrypting the system files. Since encryption functionality is built into the operating system, the ransomware may simply access files, encrypt the files with an attacker-controlled key, and then replace the original versions of the files with the encrypted versions. Most ransomware variants are cautious in their selection of files to encrypt to ensure system stability and thus avoid detection, or at least timely detection. A scan of the filesystem by the ransomware, also referred to as a “scanning phase,” enables the ransomware to map the files that were chosen to be encrypted. Some variants of ransomwares will also take steps to delete backup and shadow copies of files to make recovery of the files without the ransomware decryption key more difficult.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture and environment for an embodiment of the invention.

FIG. 2 discloses aspects of a snapshotting and sampling configuration according to an embodiment.

FIG. 3 discloses an example method according to an embodiment.

FIG. 4 discloses an example computing entity configured and operable to perform any of the disclosed methods, processes, and operations.

### DETAILED DESCRIPTION OF SOME EXAMPLE EMBODIMENTS

Embodiments of the present invention generally relate to detection and identification of malware, such as ransomware. More particularly, at least some embodiments of the invention relate to systems, hardware, software, computer-readable media, and methods, for using a group of focused snapshots to identify possibly problematic write processes.

In one example embodiment, write processes running in a system may be monitored. A ransomware process may involve a significant number of writes, due to overwriting system data with encrypted data. In other cases, a ransomware process may implement a small write, such as simply changing the header of a file, which may be enough to render the file inaccessible.

Thus, a series of small snapshots, also referred to herein as ‘zoomed in’ (ZI) snapshots since the snapshots may be taken at a relatively high frequency within a defined timeframe, may be taken of write processes, and/or other ransomware processes that may or may not involve writes, that are occurring in the system. These zoomed in snapshots, which may comprise information about running processes, including the number of writes being performed by the processes, may be randomly sampled, and those sampled zoomed in snapshots that indicate processes that may relate to ransomware, or have a high analyzed risk of being related to ransomware, may be flagged as possibly problematic. It is noted that because snapshotting imposes some cost, at least in terms of resource consumption, flagging may precede analysis, and not all flagged snapshots may necessarily be analyzed. Information in the flagged zoomed in snapshots may then be analyzed, such as in a sandbox for example, to determine if the processes, or portions of processes, captured by the zoomed in snapshots are ransomware processes. If so, information about the structure and operation of the ransomware process may be obtained through the analysis, and appropriate remedial action can be taken to stop the ransomware process, recovery of any compromised data, and to prevent future ransomware processes from running.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of one embodiment of the invention is that information may be captured that may enable subsequent detailed analysis of ransomware to identify and understand its operational mechanism. An embodiment may be relatively lightweight in terms of its operation inasmuch as it may capture process information without imposing an undue load on production operations or on computing resources. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of An Example Architecture and Environment

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts May be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM). Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

It is noted that as used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

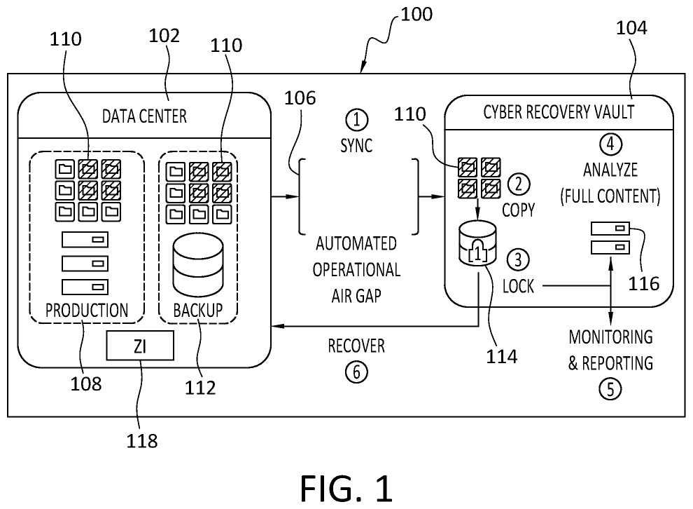

With particular attention now to FIG. 1, details are provided concerning aspects of an example operating environment 100 in which example embodiments may be employed. In the illustrative, and non-limiting, example of FIG. 1, a data center 102 is configured for communication with a vault 104 to which data from the data center 102 can be backed up. The vault 104, which may take the form of a Dell Cyber Recovery vault for example, may be isolated from the data center 102, except under specified conditions, by a physical air gap 106. In general, the nature of the air gap 106 is such that when the air gap 106 is in place, that is, the air gap 106 is open, there is no physical or other connection between the vault 104 and the data center 102, thus ensuring the security and integrity of any data stored in the vault 104. Security procedures may be implemented that provide for selective closing of the air gap 106, for a limited time, so that the data center 102 and the vault 104 can communicate with each other. In at least some instances, the vault 104 may control the opening and closing of the air gap 106.

The data center 102 may include a production system 108 in which data 110 is generated. Some or all of the data 110 may be backed up to, or at least accessible by way of, a namespace in a backup environment 112 of the data center 102. Some or all of the data 110 in the namespace of the backup environment 112 may be replicated to the vault 104. Particularly, the vault 104 may include, or provide, a namespace 114 configured to receive a PIT (point in time) copy of the namespace that was replicated from the backup environment 112. Finally, the vault 104 may comprise a further namespace 116, which may be referred to herein simply as a ‘sandbox’ or ‘sandbox namespace.’

Various operations may be performed in the operating environment 100, as described hereafter. The data 110 journey may begin when it is created or modified in the production system 108 and then backed up to a namespace in the backup environment 112. A subset of the data 110, such as a group of files, in the backup environment 112 may then be replicated over (1) to the vault 104. In general, the vault 104 may serve as another backup environment, and may be air gapped, as described earlier herein. After the data 110 has landed in the vault 104 namespace, a Point In Time (PIT) copy of that namespace is copied over (2) to another namespace in the vault 104, and the copy then retention locked (3). At this stage, the infrastructure, that is the vault 104, guarantees immutability of the data stream. Next, this locked copy of the data 110 may be copied into another namespace, or sandbox. The data in the sandbox may be subjected (4) to an analyze routine, and that data and/or sandbox may also be subjected to monitoring and reporting (5), for example to determine, and report on, an outcome of the analysis (4). The analyze routine may comprise a ML algorithm which scans the data 110 in the sandbox for malware, such as ransomware for example. If any malware is detected, that is reported. If the scan does not reveal any problems, then the sandbox, that is, the namespace to which the locked data was copied, is marked as ‘deleted’ once the process is complete. At some point thereafter, the data in the vault 104 may be recovered (6) to the data center 110.

In an embodiment, the analyze routine, or another routine running in the vault 104 may analyze ZI snapshots, which may be captured by a ZI module 118 running in the datacenter 102, such as in the production system 108 and/or in the backup system 112 for example, while production processes are running. Such production processes may include, but are not limited to, creating new/modified data, and backing up that data. The ZI snapshots may be transmitted from the data center 102 to the vault 104 for storage and analysis. In an embodiment, the ZI snapshots may be stored in the sandbox 116 so that the ZI snapshots can be safely analyzed without posing a risk to data and operations in the data center 102.

### B. Aspects of One or More Example Embodiments

### B.1 Introduction

As noted herein, data encryption processes such as are performed by some ransomware are heavy, in the sense that they typically perform many write operations, and possibly at a relatively fast tempo, and/or write operations that are relatively complex. To understand the structure and function of a ransomware process, an embodiment may provide zoomed-in information about the writing operation performed by the process. In case the process is found to comprise ransomware, especially file-less ransomware, that information may be obtained for analysis. Note that as used herein, ‘fileless’ ransomware embraces, but is not limited to, ransomware that uses legitimate programs to perform ransomware processes, such as data encryption and data overwriting. By definition, fileless ransomware does not require a ransomware file or other ransomware executable to perform the ransomware processes, and a fileless ransomware process may not leave a footprint, which may make it difficult to detect. Where fileless ransomware is known, or suspected, to be operating, ZI snapshots may be taken of the relevant portion(s) or the RAM.

An embodiment may thus take multiple snapshots of the process while, for example, the process is overwriting data such as one or more files for example. In order not to slow down the operation of the system where the process is running, an embodiment may sample zoom-in snapshots randomly with some low probability. Processes that are write-intensive may be relatively more likely to be zoomed in. An embodiment may provide for whitelisting of known programs and system processes. One embodiment may only add processes to the list of candidate processes for zoom-in snapshotting if those processes performed more than X writes, for example, or a certain number of writes within a specified timeframe, or over a threshold of one or more type(s) of operations. The zoom-in snapshots may be analyzed, such as in a vault for example, to determine if the process is a ransomware, and/or to determine the operational mechanism of the process.

It is noted that the manner of taking the ZI snapshots may vary. The following examples are illustrative, but are not intended to limit the scope of the invention in any way. As discussed below, embodiments of the invention may provide various different schemes for taking ZI snapshots. In some cases, one or more schemes may be combined and implemented in a single embodiment.

For example, in some circumstances, it may be problematic to randomly take ZI snapshots. In such cases, the ZI snapshots may be taken at predetermined intervals of time. In one particular embodiment, the intervals of time may be fixed, but that is not necessarily required. As discussed below, other embodiments may provide for taking ZI snapshots at time intervals that are not necessarily fixed. Put another way, alternative embodiments may provide for taking ZI snapshots at various different frequencies, according to various different criteria.

Thus, an embodiment may vary the frequency with which ZI snapshots are taken. The change in frequency, and the timing of the change, may be based on the stage of operation of the ransomware. To illustrate, a ransomware process may comprise multiple step, such as setup, data transfer, encryption/corruption, and negotiation. Each of these steps or stages of a ransomware process may be associated with a different respective ZI snapshot frequency, and the changes in frequency may be implemented, for example, when a ransomware process moves to a different stage. The timing of a frequency change, and the new frequency, may be provided by a user, or determined by AI/ML. In an embodiment, a frequency change scheme may be defined ahead of time, and triggered, possibly automatically, when a suspected ransomware process is identified.

In an embodiment, frequencies of ZI snapshotting may be determined based on the dissimilarity of a process relative to other, possibly known, ransomware processes. In particular, some advanced ransomware may exhibit multiple phenotypic behavior. For example, a ransomware may perform a different respective encryption process for each file type. Thus, an embodiment may determine, by analysis of ZI snapshots, that there is already a sufficient number of recorded ZI snapshots for a certain phenotype.

In an embodiment, the timing and/or frequency of ZI snapshots may be based on the dissimilarity of a process to known malware. Presently, there are many known instances of Ransomware as a Service (RaaS), where ransomware families are largely copied for many uses. Rather than analyzing such a copied ransomware for its mechanism, an embodiment may instead focus on the start point, that is, when the ransomware process began, and keys that are generated by the ransomware.

In an embodiment, the timing and/or frequency of ZI snapshots may be based on the relative importance of the data involved. The importance of the data may be determined, for example, with reference to metadata about the data, where such metadata may comprise, for example, a frequency with which the data is accessed, the owner of the data, the location of the data, the size of the data, the creation date of the data, the number of users who access the data, and whether or not that data has previously been targeted by ransomware, which ransomware, how many times, and when. Thus, relatively more valuable files may be more likely targets for ransomware, and an embodiment may provide greater assurance and insights about what has happened, and is happening, to that data.

Finally, in an embodiment, one or more ZI snapshots may be taken in response to one, or more, triggering events. For example, a ZI snapshot may be taken after a change to a file header is detected. As another example, a ZI snapshot may be performed within a set time period, such as one second for example, after the most recent write to a file.

### B.2 Detailed Discussion

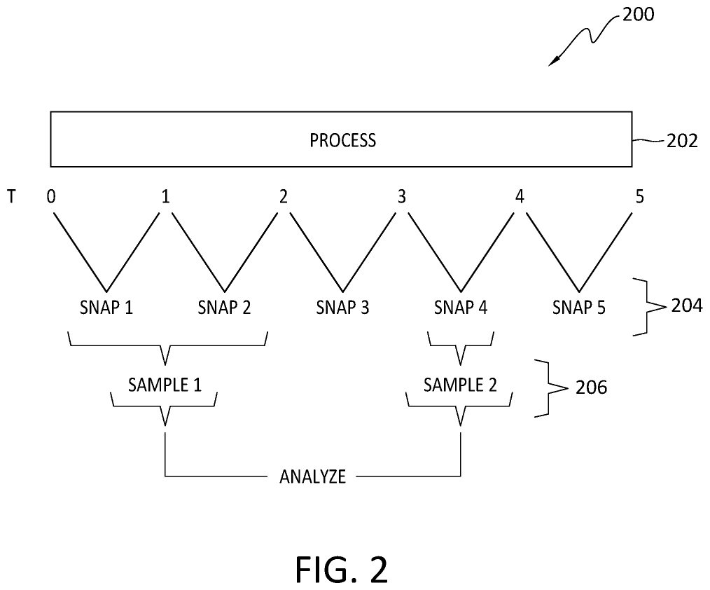

With reference now to FIG. 2, details are provided concerning aspects of an example embodiment of the invention. In the example configuration 200 of FIG. 2, a process 202 may be running, such as in a datacenter for example. The process 202 may comprise, for example, various write operations, and may be one of a number of processes running at any given time. In an embodiment, the process 202 may be overwriting one or more files or other groupings of data.

While the process 202 is running, a number of ZI snapshots 204 may be taken of the process 202. In an embodiment, all running processes may be snapshotted. Alternatively, one or more particular processes may be selected for snapshotting. This selection may be based, for example, on where the process is running, and the nature of the process. For example, a read process may not be of interest in some embodiments, while many write processes may be of interest. As another example, a process running in a backup environment may be of particular interest insofar as that process may be writing data that is to be protected. Thus, the processes, such as process 202, to be snapshotted may be specified based on various criteria.

In an embodiment, any number of ZI snapshots 204 may be taken. For example, a number of ZI snapshots, which are relatively small in size, may be taken. That is, each of the ZI snapshots may cover a relatively short period of time, relative, for example, to an overall length of the process 202.

Attributes such as, but not limited to, the number, timing, and timespan, of ZI snapshots 204 may be specified by an admin or automatically, and the scope of the invention is accordingly not limited to any particular number, timing, and timespan, of ZI snapshots 204. The ZI snapshots 204 may be taken one right after the other to form a continuous string of snapshots such that ZI snapshots 204 are obtained that completely capture the entire process 202. In an embodiment, however, it may not be necessary, or desirable, to capture the entire process 202 and, as such, the ZI snapshots 204 may capture only one or more selected portions of the process 202. For example, and with reference to FIG. 2, the ZI snapshot ‘snap2’ may be omitted, such that there is a portion of the process 202 between time T1 and T2 that is not captured by a ZI snapshot 204. In an embodiment, enough ZI snapshots 204 may be taken that enable an analysis of the process 202 that is adequate to determine whether or not the process comprises a ransomware process, but not so many ZI snapshots 204 are taken as to impair operations in the environment where the process 202 is running.

The ZI snaps 204 may be stored locally where the associated process 202 is, or was, running and/or may be transmitted to a vault for storage. In an embodiment, fewer than all of the ZI snaps 204 may be considered for analysis. That is, as shown in the example of FIG. 2, the ZI snapshots 204 taken for the process 202 may be sampled for analysis. In the illustrated example, two samples 206 are shown. One of the samples 206 comprises multiple ZI snaps 204, and another sample 206 comprises just one ZI snap 204. In an embodiment, the sampling of the ZI snaps 204 may be performed randomly. In an embodiment, processes 202 that comprise a significant number of write operations may be more likely to be sampled, and may be sampled more often, than other processes. In some embodiments, there may be one or more processes that are not snapshotted, or sampled.

In an embodiment, the process 202 may be snapshotted, and the ZI snapshots sampled, based on one or more particular attributes of the process 202. For example, in an embodiment, a counter may be provided that tracks the number of write operations performed by a process 202. When the counter value exceeds a threshold, automatic snapshotting of the process 202 may be triggered, and the snapshotting, and subsequent sampling, may be performed according to previously specified parameter values, and/or the parameter values may be determined on-the-fly as snapshotting and sampling are performed. In an embodiment, a counter may be implemented for each process that is being monitored, and snapshotting may be omitted for any processes whose counter does not exceed a threshold. In an embodiment, processes whose write count exceeded a threshold may be added to list, and processes selected from that list for snapshotting.

Parameters such as the size, frequency, and timing, of a sampling process may be varied. In an embodiment, a machine learning (ML) model and/or artificial intelligence (AI) may determine values for these and/or other sampling parameters. Likewise, in an embodiment, an ML model and/or AI may determine values for parameters such as, but not limited to, the number, timing, and timespan, for one or more ZI snapshots.

In an embodiment, known programs and/or processes may be whitelisted such that no monitoring or snapshotting of those programs and processes is performed. This approach may enable a more focused monitoring of processes, while also conserving computing resources.

Finally, and with continued reference to FIG. 2, the ZI snapshots 204 in the samples 206 may be analyzed. In an embodiment, the analysis may be performed in a vault which may be isolated from a production site, such as a datacenter, by way of an air gap. In an embodiment, an outcome of the analysis, which may be performed by ML/AI, may be information about the structure and operation of the process concerning which the analysis was performed. Among other things, an analysis may reveal that the process comprises a ransomware process, and/or another malicious process directed to processes and/or data.

### C. Example Methods

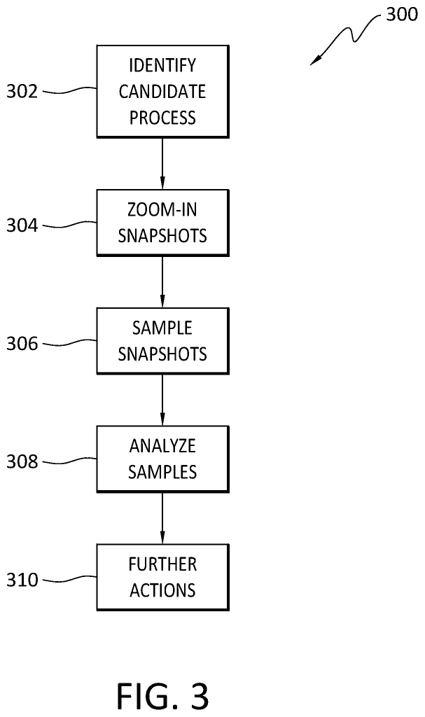

It is noted with respect to the disclosed methods, including the example method of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 3, a method according to one example embodiment is denoted generally at 300. The example method 300 may begin when one or more processes are identified 302 as candidates for monitoring. The processes may comprise a process known, or expected, to perform a processes that may relate to ransomware, or have a high analyzed risk of being related to ransomware, may be flagged as possibly problematic, which may be indicative, in some cases, of a ransomware process. The process(es) may run in a production environment, such as a data backup environment for example where data is written to, and stored in, backup storage, but no particular operating environment is required in any particular embodiment.

After the candidate processes have been identified, and are running, one or more zoom-in snapshots may be taken 304 while the process is running. As disclosed herein, various parameters may be used, in an embodiment, to guide the process for taking the zoom-in snapshots 304. The zoom-in snapshots may then be stored, possibly in a vault for example.

After the zoom-in snapshots have been taken 304, the zoom-in snapshots may be sampled 306. The sampling process 306 may or may not be performed randomly. In a non-random sampling operation, zoom-in snapshots corresponding to one or more particular timeframes of interest of a process may be sampled 306. In an embodiment, ZI snapshots may be sampled on a fixed interval basis. In an embodiment, the ZI snapshots may be randomly sample.

The sampled 306 zoom-in snapshots may then be analyzed 308, possibly in real time as the zoom-in snapshots are taken, or received at a vault. In an embodiment, the analysis 308 may be performed in a vault that is isolated from a production site, or other site, where the running of the snapshotted process, as part of the analysis 308, could compromise other processes, and data. As such, use of a vault may enable an in-depth analysis 308 that may not be possible without the use of a vault for isolation.

There may be various outcomes as a result of the performance of the analysis 308. In an embodiment, the outcome of the analysis 308 may be the performance of one or more further actions 310. For example, if the analysis 308 reveals that the process comprises a ransomware process, various security and control measures may be put in place in the production system to detect, and shut down, ransomware processes the same as, or similar to, the process that was analyzed 308. For example, with knowledge gained from the analysis 308 about the structure and operation of the ransomware, existing systems and/or processes may be modified to reduce the likelihood that such a future ransomware attack will be successful, and to increase the likelihood that future ransomware attacks will be timely detected, and dealt with. It is noted that in some cases, the analysis 308 may reveal that the process is not a ransomware process, such that no further action need be taken. In such a case, the process may be whitelisted so that it no longer requires monitoring, thus freeing computing resources for other tasks.

In an embodiment, the operations 302, 304, and 306, may be performed in a production environment, such as a datacenter for example. In an embodiment, the operations 306 and 308 may be performed at a secure site, such as vault for example. In general however, no particular disclosed operation is necessarily required to be performed at any particular system or site.

### D. Further Example Embodiments

Following are some further example embodiments of the invention. These are presented only by way of example and are not intended to limit the scope of the invention in any way.

Embodiment 1. A method, comprising: identifying a candidate process for monitoring; while the candidate process is running, taking a set of snapshots of the candidate process, wherein each of the snapshots corresponds to a respective time period during which the candidate process was running; and analyzing the sampled snapshots to determine whether the candidate process comprises a ransomware process.

Embodiment 2. The method as recited in any preceding embodiment, wherein when it is determined that the candidate process does not comprise a ransomware process, the candidate process is added to a whitelist.

Embodiment 3. The method as recited in any preceding embodiment, wherein when a counter indicates that the candidate process comprises a number of write operations that exceeds a threshold, the candidate process is identified as a ransomware process.

Embodiment 4. The method as recited in any preceding embodiment, wherein the snapshots are analyzed in a vault that is isolated by an air gap from a production site where the process runs.

Embodiment 5. The method as recited in any preceding embodiment, wherein the snapshots are analyzed in real time as they are taken.

Embodiment 6. The method as recited in any preceding embodiment, wherein the candidate process comprises a file overwriting process.

Embodiment 7. The method as recited in any preceding embodiment, wherein analysis of the snapshots reveals the candidate process to comprise a ransomware process.

Embodiment 8. The method as recited in embodiment 7, wherein the ransomware process comprises a fileless ransomware process.

Embodiment 9. The method as recited in any preceding embodiment, wherein the snapshots are taken while the candidate process is overwriting a file.

Embodiment 10. The method as recited in any preceding embodiment, wherein a known program or known process is whitelisted before the snapshots are taken of the candidate process.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

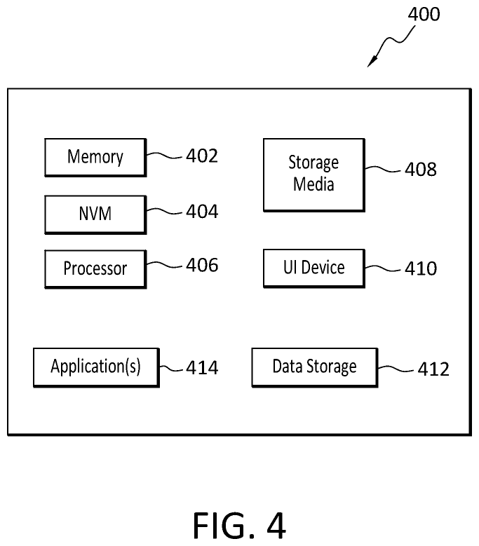

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
identifying a candidate process for monitoring;
while the candidate process is running, taking a set of snapshots of the candidate process, wherein each of the snapshots corresponds to a respective time period during which the candidate process was running; and
analyzing the snapshots to determine whether the candidate process comprises a ransomware process.

2. The method as recited in claim 1, wherein when it is determined that the candidate process does not comprise a ransomware process, the candidate process is added to a whitelist.

3. The method as recited in claim 1, wherein when a counter indicates that the candidate process comprises a number of write operations that exceeds a threshold, the candidate process is identified as a ransomware process.

4. The method as recited in claim 1, wherein the snapshots are analyzed in a vault that is isolated by an air gap from a production site where the process runs.

5. The method as recited in claim 1, wherein the snapshots are analyzed in real time as they are taken.

6. The method as recited in claim 1, wherein the candidate process comprises a file overwriting process.

7. The method as recited in claim 1, wherein analysis of the snapshots reveals the candidate process to comprise a ransomware process.

8. The method as recited in claim 7, wherein the ransomware process comprises a fileless ransomware process.

9. The method as recited in claim 1, wherein the snapshots are taken while the candidate process is overwriting a file.

10. The method as recited in claim 1, wherein a known program or known process is whitelisted before the snapshots are taken of the candidate process.

11. A non-transitory storage medium having stored therein instructions that are executable by one or more hardware processors to perform operations comprising:
identifying a candidate process for monitoring;
while the candidate process is running, taking a set of snapshots of the candidate process, wherein each of the snapshots corresponds to a respective time period during which the candidate process was running; and
analyzing the sampled snapshots to determine whether the candidate process comprises a ransomware process.

12. The non-transitory storage medium as recited in claim 11, wherein when it is determined that the candidate process does not comprise a ransomware process, the candidate process is added to a whitelist.

13. The non-transitory storage medium as recited in claim 11, wherein when a counter indicates that the candidate process comprises a number of write operations that exceeds a threshold, the candidate process is identified as a ransomware process.

14. The non-transitory storage medium as recited in claim 11, wherein the snapshots are analyzed in a vault that is isolated by an air gap from a production site where the process runs.

15. The non-transitory storage medium as recited in claim 11, wherein the snapshots are analyzed in real time as they are taken.

16. The non-transitory storage medium as recited in claim 11, wherein the candidate process comprises a file overwriting process.

17. The non-transitory storage medium as recited in claim 11, wherein analysis of the snapshots reveals the candidate process to comprise a ransomware process.

18. The non-transitory storage medium as recited in claim 17, wherein the ransomware process comprises a fileless ransomware process.

19. The non-transitory storage medium as recited in claim 11, wherein the snapshots are taken while the candidate process is overwriting a file.

20. The non-transitory storage medium as recited in claim 11, wherein a known program or known process is whitelisted before the snapshots are taken of the candidate process.
